(19) United States
(12) Patent Application Publication
(10) Pub. No.: US 2017/0324606 A1
(43) Pub. Date: Nov. 9, 2017

(54) SERIAL COMMUNICATIONS TAP DEVICE

(71) Applicant: DataMetrex Limited, Toronto (CA)

(72) Inventor: Jonathan Hobbs, Dunrobin (CA)

(73) Assignee: DataMetrex Limited, Toronto (CA)

(21) Appl. No.: 15/590,529

(22) Filed: May 9, 2017

Related U.S. Application Data
(60) Provisional application No. 62/333,612, filed on May 9, 2016.

(51) Int. Cl. H04L 29/06; H04L 29/08

(52) U.S. Cl. CPC H04L 29/06068; H04L 69/324; H04L 69/03; H04L 69/08; H04L 69/14

(57) ABSTRACT

A serial tap device consists of a first serial port, a second serial port directly connected to the first serial port by multiple serial lines, and a switch configured to selectively connect one or more of the multiple serial lines to a convertor module. The convertor module is configured to convert serial communications signals from the one or more serial lines to transistor-transistor logic (TTL) level signals. The serial tap device includes a communications module and a processor which operates to capture data from the TTL level signals, generate packets containing the captured data, and transmit the packets to a communications network, such as the internet, through the communications module. The serial tap device may be connected inline, between two serial devices, in order to capture data exchanged in serial communication flows between the devices and transmit the captured data to a remote server.

### TECHNICAL FIELD

Example embodiments relate to the fields of serial communications protocols and data transmissions.

### BACKGROUND

The Internet is a global system of interconnected computers and networks that utilize the TCP/IP (Transmission Control Protocol/Internet Protocol) to communicate. The “Internet of Things” (IOT) is the concept in which a wide variety of physical objects connect to the Internet.

Many legacy devices are not TCP/IP capable and do not have the ability to connect to the internet. A variety of market forces are driving the need to have legacy devices, and the data they contain, become contributing members of the IOT.

### SUMMARY

The present application describes devices and systems which enable data flowing between two devices using a serial communications protocol to be captured and transmitted to a communications network, such as the Internet, without impacting the data flows between the two devices.

According to one embodiment of the present application there is provided a serial tap device which includes a first serial port, a second serial port directly connected to the first serial port by multiple serial lines; a switch configured to selectively connect one or more of the multiple serial lines to a convertor module, the convertor module being configured to convert serial communications signals from the one or more connected serial lines to transistor-transistor logic (TTL) level signals; a communications module; and a processor. The processor is configured to: capture data from the TTL level signals received from the convertor module, generate packets containing the captured data, and transmit the packets to a communications network through the communications module.

According to another embodiment of the present application there is provided a serial tap device which includes a first serial port, a second serial port directly connected to the first serial port by multiple serial lines; and a convertor module connected to a selected subset of the multiple serial lines. The convertor module is configured to convert serial communications signals captured from the connected serial lines to transistor-transistor logic (TTL) level signals. The serial tap device includes a communications module; and a processor; the processor is configured to capture data from the TTL level signals received from the convertor module, generate packets containing the captured data, and transmit the packets to a communications network through the communications module.

### BRIEF DESCRIPTION OF THE DRAWINGS

Reference will now be made, by way of example, to the accompanying figures which show example embodiments of the present application, and in which:

FIG. 1 is a block diagram illustrating a system in accordance with one embodiment of the present disclosure;

FIG. 2 is a block diagram illustrating a serial tap device in accordance with one embodiment of the present disclosure;

FIG. 3 is a block diagram illustrating a serial tap device in accordance with another embodiment of the present disclosure; and

FIG. 4 is a block diagram illustrating a serial tap device in accordance with another embodiment of the present disclosure.

Like reference numerals are used throughout the figures to denote similar elements and features.

While the invention will be described in conjunction with the illustrated embodiments, it will be understood that it is not intended to limit the invention to such embodiments. On the contrary, it is intended to cover all alternatives, modifications and equivalents that may be included within the spirit and scope of the invention described herein.

### DETAILED DESCRIPTION OF EXAMPLE EMBODIMENTS

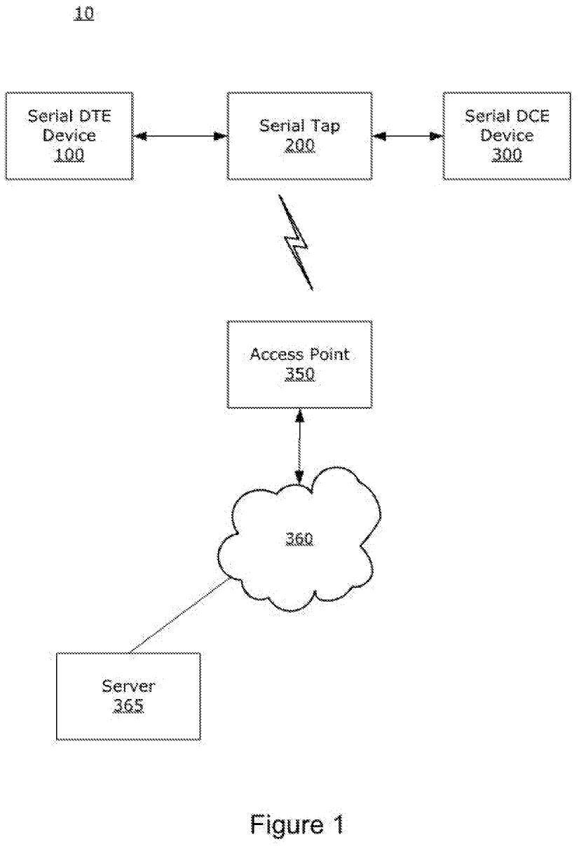

As depicted in FIG. 1, in a system 10 according to the present disclosure there is provided a serial tap device 200 which is connected inline, between two serial devices 100, 300 in order to capture data exchanged in serial communication flows between the devices 100, 300. The serial tap device 200 extracts the data contained within the communication flows and forwards said data, via communications to an access point 350. The access point 350 then forwards the data through a communications network 360, such as the internet, to a remote server 365 or other device connected to the internet. Although illustrated as a single “cloud” in FIG. 1, communications network 360 may consisted of multiple wired and wireless public and/or private networks.

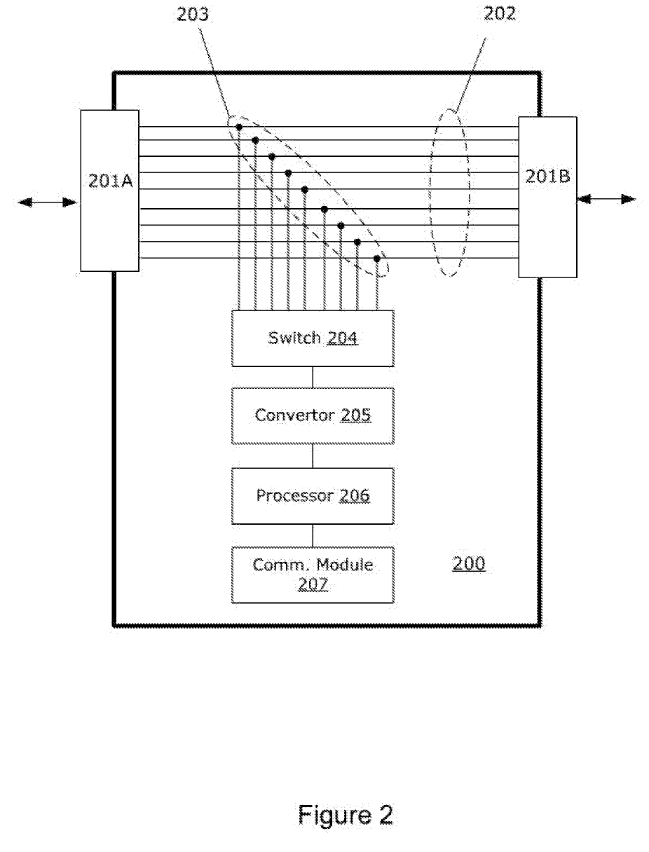

FIG. 2 illustrates one embodiment of the serial tap device 200. The components of the device 200 include two serial ports 201A, 201B; serial lines 202 connecting the two serial ports; selected physical connections 203 between the serial lines 202 and a switch 204; a convertor module 205 that is connected to a processor 206; and a communications module 207 connected to the processor 206. In an alternative embodiment, there is no switch and one or more selected physical connections 203 are directly connected to the convertor module 205.

Serial device 100 is typically a computer, but can be any type of serial communications Data Terminal Equipment (DTE) device. DTE devices may be computers, point-of-sale terminals, or any other device that acts as a DTE device.

Serial device 300 is any type of serial communications Data Communication Equipment (DCE). DCE devices may be modems, scanners, monitors/displays, printers or any other device that acts as a DCE device.

Within serial tap device 200, the two serial ports, 201A, 201B are physically connected or hardwired directly together by the serial lines 202, so that the serial pins of the each port 201A, 201B are matched together e.g. pin 1 of port 201A is connected to pin 1 of port 201B and so on. The direct physical connection of the ports through serial lines 202 ensures that any failure of serial tap device 200 does not affect communications between serial devices 100 and 300.

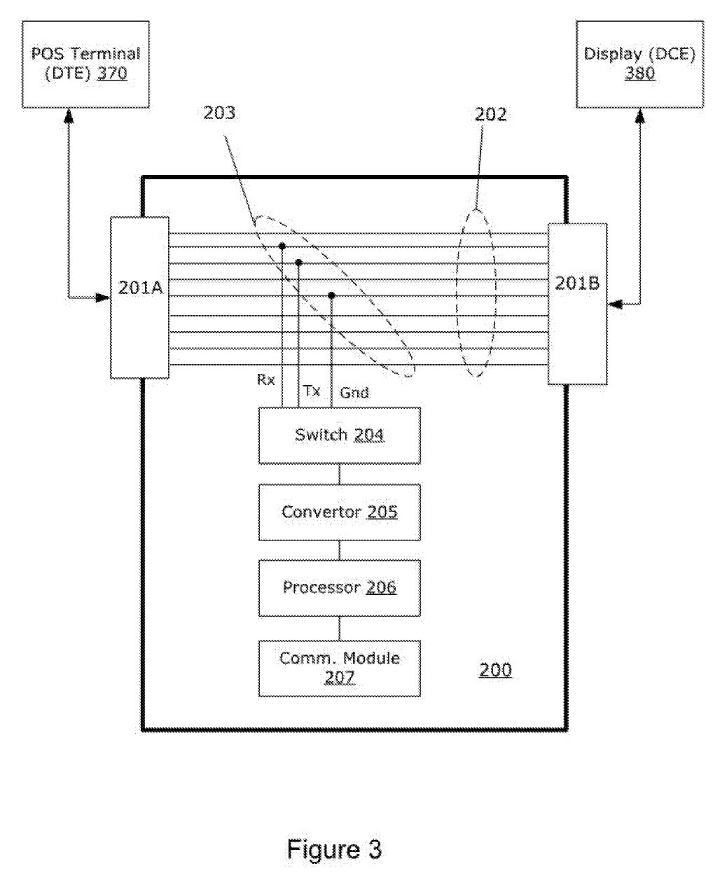

Multiple physical connections 203 are made between the lines of the two serial ports and either switch 204 or the convertor module 205. As shown in FIG. 2, every serial line 202 between port 201A and 201B may be connected to the switch 204. In other configurations, the serial tap device 200 may be configured to support a specific serial communications protocol. For example, in RS-232 serial communications, as shown in FIG. 3 and described in further detail below, the receive (Rx) and transmit (Tx) data lines, and the ground (GND) line would have physical connections 203 with the switch 204 or the convertor module 205. In some embodiments, one or more diodes may be placed between the physical connections 203 and the convertor module 205 to prevent any interference in communications between the two serial devices 100, 300.

In one embodiment the switch 204 allows for selection of which serial lines are to be connected to the convertor module 205. The switch 204 can be a manually switch such as one or more dipswitches (not shown) in the serial tap device 200. The switch 204 may be operated by electrical signals, or operated by software commands executed by the processor 206. Alternative embodiments may have no switch and may have one or more serial lines directly connected to the convertor module 205.

A manually operated switch 204 would enable the user to pre-select which serial lines are to be tapped. A software operated switch would allow the user to select which serial lines are to be tapped by having the processor 206 access a configuration file, or acquire configuration information from the user via a user-interface (not shown) which then causes the processor 206 to send commands to the switch to tap the specified serial lines. In one embodiment, the serial tap device 200 includes a memory (not shown) which stores the configuration file. In one embodiment, an electrically operated switch could detect voltages on the communication lines and automatically tap active communication lines. Thus, the serial tap device 200 may be provided in a generic form and configured for use to monitor signals being transmitted between serial devices 100, 300 according to one of a number of different standards. Serial communications according to various standards may be tapped, including, but are not limited to: RS-232, PS/2, RS-422, RS-423, RS-485, SDI-12, SPI, 1-Wire, I2C, Universal Serial Bus (USB), or Musical Instrument Digital Interface (Midi) communications. The configuration file may contain the parameters needed, if any, for accessing communications according to the target communications protocol. For example, for RS-232 communications, the configuration file includes parameters such as baud rate, and information regarding parity, stopbits and databits. The configuration file also may store parameters and values used for communications by the serial tap device 200 to the remote server 365. The stored parameters may include the remote server address or URL, a local wireless network identifier (such as a WiFi SSID), and password. If applicable, the configuration file also may store an identifier, password and/or certificate information for secure communications, such as transport layer security (TLS) or secure sockets layer (SSL) communications.

The convertor module 205 is either connected to switch 204 or directly connected to physical connections 203. Optionally, diodes can be placed between the physical connections 203 and the convertor module 205 to prevent any interference in communications between the two serial devices 100, 300. The convertor module 205 is also connected to the processor 206. The convertor module 205 converts the serial signals being transmitted at differential voltage levels on the serial lines 202 to a Transistor-Transistor Logic (TTL) voltage level. In one embodiment, convertor module 205 is a single integrated circuit (IC), however in alternative embodiments, the convertor module 205 can comprise: one or more integrated circuits, a processor and related electronic circuitry, memory and software. As an example, in the embodiment which taps RS-232 communications, the convertor module 205 is configured to convert the RS-232 voltages, of +/−25 volts, to TTL voltages of 0 to 3.3, or 0 to 5 volts (depending on the processor requirements). In this embodiment or configuration, the convertor module 205 would also invert the bit representation so that the RS-232 logic high (‘1’ bit) represented by negative voltage (−3 v to −25 v) would become a TTL positive voltage of 2.2 v to 5 v. Likewise, the RS-232 logic low (‘0’ bit) represented by positive voltage (3 v to 25 v) is converted to a TTL voltage in the range 0 v-0.8 v. The convertor module 205 may also include circuitry (diodes) to eliminate current backflow that may interfere with communications between the serial devices 100, 300.

The processor 206 is connected to the convertor module 205 and receives incoming TTL level signals from the convertor module 205. The processor 206 transforms the incoming TTL level signals (“0” and “1” bits) and captures data or content from these signals into data bytes (such as ASCII 7 or 8 bit data, Unicode, etc.). This transformation and data capture is achieved by the execution of software by the processor 206. Similar to the steps described above, the processor 206 is configured to operate in a specific environment and to process data collected from a specific type of serial communications connection between particular types of serial devices 100, 300, such as but not limited to a retail point of sale device and a display. The processor 206 may be preconfigured for a specific environment, or it may be configured through a configuration file or through a user interface.

The processor 206 executes the software instructions to assemble and format packets of the captured data into a pre-determined format that is suitable for use by the remote server 365 that will receive and analyze the data packets. The pre-determined format will define parameters such as: data storage (such as comma-separated values (CSV), tab-separated values); data value type (such as hexadecimal, octal, decimal); data encoding format (such as ASCII or Unicode); and data length (amount of data sent in each packet can be fixed or variable). As an example, in one embodiment the processor 206 converts the incoming TTL level signals into 8 bit ASCII values and uses the CSV format to bundle 1024 bytes of data into a single data packet. The processor 206 creates an HTTP formatted request to deliver the data packets to the remote server 365. The processor 206 then sends this data packet to the communications module 207 for delivery to the remote server 365 using the TCP/IP protocol.

Optionally, in some embodiments, the processor 206 executes software and operates to filter the captured data, according to a pre-determined filtering algorithm, and only passes to communications module 207 data which meets the filtering criteria. For example, in one embodiment, the processor 206 is configured to ignore or not process captured data which does not relate to the communication of data between the serial devices 100, 300. This may include, for example, the processor 206 being configured not to process control commands or non-data related commands or communications, such as, “are you alive” queries, and “still alive” messages which are exchanged between a personal computer (100) and a printer (300). In other embodiments, the processor 206 and serial tap device 200 may be configured to filter and capture specific information, such as data communications between two serial devices 100, 300 in a retail sales environment. Such targeted communications may contain, for example, a Universal Product Code (UPC) consisting of 12 numeric digits. Because the first 5 digits of the UPC are specific to a manufacturer, these digits could be used to filter and capture only data and communications related to products for a specific manufacturer. In some configurations, pricing data could be captured by a processor 206 configured to filter or capture information that corresponds to a dollar sign followed by a floating point number with 2 decimal places of precision. In other configurations, specific product names could be filtered and captured (e.g. a product name, description or trademark such as “coke”).

The communications module 207 receives data packets from the processor 206 and forwards the data packets to an access point 350. The connection between the serial tap device 200 and the access point 350 may be wired or wireless. The access point 350 may be, for example, a router, switch, or WiFi™ access point that communicates with the communications network 360. In one embodiment wireless communications is achieved using WiFi technology. In alternative embodiments, the communications module 207 may be configured transmit data packets according to any form of wireless transmission, including but not limited to: wireless local area network communications such as WiFi; short range wireless communications such as Bluetooth™ or Zigbee™; or cellular communications such as code-division multiple access (CDMA); time-division multiple access (TDMA); Global System for Mobile Communications (GSM™); Universal Mobile Telecommunications System (UMTS); Long-Term Evolution (LTE™); General Packet Radio Service (GPRS); Evolution-Data Optimized (EVDO); Enhanced Data rates for GSM Evolution (EDGE); or Integrated Digital Enhanced Network (iDEN).

Access point 350 then forwards the data packets, received from communications module 207, to a server, computer or other device (not shown) which is connected to the communications network 360.

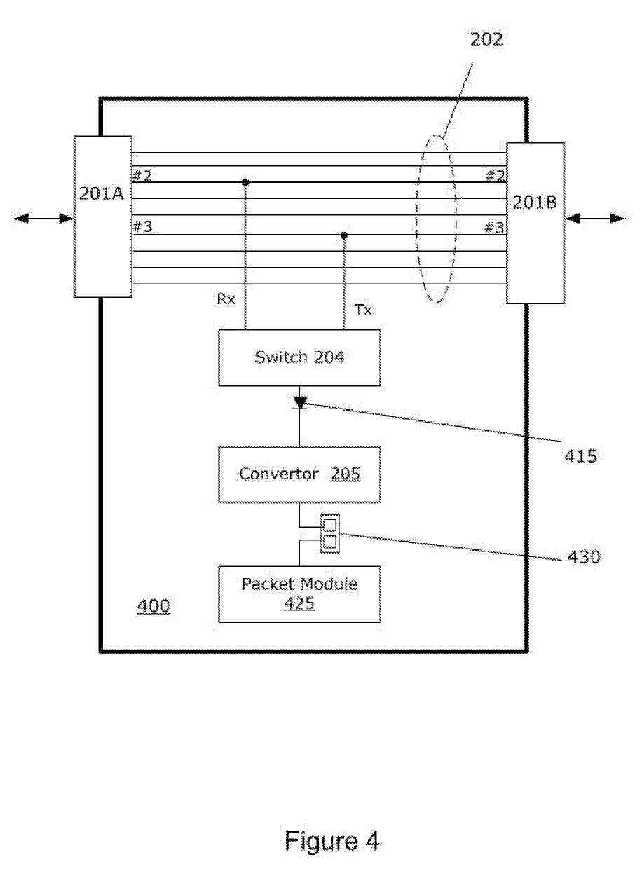

FIG. 4 illustrates a further embodiment of a serial tap device 400 for tapping RS-232 data transmissions according to the present disclosure. In this embodiment, switch 204 is operable to selectively connect between an Rx or Tx line of the serial lines 202, which are marked as pins #2 and #3, respectively, in FIG. 4. The switch 204 is connected to the convertor module 205 through a diode 415. The convertor module 205 may comprise an integrated circuit such as an RS-232 transceiver like the Maxim™ MAX3232EIPWR, which converts serial data to TTL level voltages as described above. In this embodiment, a packet module 425 performs the various functions, and the various combinations of functions, of the processor 206 and the communications module 207, as described above. The packet module 425 may comprise an Expressif Systems ESP8266™ module which is programmable to perform the processing and data transmissions functions described herein. In one embodiment, the serial tap device 400 includes a jumper 430 to selectively connect the convertor module 205 to the packet module 425. This enables the packet module 425 to be disconnected from the convertor module 205 during configuration so that the packet module 425, such as the ESP8266™, may be programmed using its serial interface and then reconnected to the convertor module 205 to receive data from tapped from the serial lines 202 and converted by the convertor module 205. In other embodiments, the jumper 430 may be replaced with a manually operated switch such as a dipswitch.

Previous devices which tap or monitor serial communication lines typically utilize inductive or capacitive coupling which can result in data loss from electromagnetic interference. The serial tap devices and systems described herein improve on these devices by utilizing direct electrical connections, so that no data loss can occur.

Other devices may also capture entire serial protocol frames and forward those frames to other locations on the network, or capture serial communication signals which are then viewed locally, stored or transmitted to other locations on the network. These devices are typically designed to provide network monitoring, network statistics, troubleshooting and signal quality monitoring.

The serial tap devices 200, 400 and system 10 described herein extract the data contained within the serial communications frames and deliver that data content over the communications network 360, such as the internet, to a remote computer or server. It does not matter to the present serial tap device 200, 400 which serial device is transmitting the data (i.e. data could be transmitted by either the DTE or DCE serial device) and it does not matter what type of DCE or DTE device or apparatus is transmitting or receiving the data. Data which has been captured, or captured and filtered, is transmitted by the serial tap devices 200, 400 through the communications network to a remote computer or server. The remote computer or server knows the environment, apparatuses and data format which is being received and can interpret and analyze the received data accordingly.

Once the data is available via the internet a variety of end-uses can be supported such as, but not limited to: data analytics, real-time feedback based on business logic, and/or data aggregation. New business models, based on the IOT, are made possible as a result of the data collected by the serial tap devices described herein.

One example of an implementation of the embodiments described herein is illustrated in FIG. 3. This illustration depicts a retail point-of-sale (POS) terminal 370, such as a cash register connected via RS-232 communications with an LCD display 380. The serial tap device 200 is connected, in-line, between the POS Terminal 370 and the display 380. All data sent from the POS Terminal 370 to the display 380, such as product stock keeping units (SKUs), prices, quantities, weights, coupons, product descriptions, discounts, or refunds may be captured by the serial tap device 200 as described herein and forwarded to the remote server 365 connected to the communications network 360.

Another example of an implementation of the embodiments described herein includes a scanner connected to a cash register. A serial tap device 200, 400 as described herein may be connected, in-line, between the cash register and the scanner. All scanned data, such as product SKUs and coupons, would be captured by the serial tap device 200, 400 and forwarded to the remote server 365 connected to the communications network 360.

Thus, it is apparent that there has been provided in accordance with the embodiments of the present disclosure serial tap devices and systems that fully satisfy the objects, aims and advantages set forth above. While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

1. A serial tap device comprising
a first serial port,
a second serial port directly connected to the first serial port by multiple serial lines;
a switch configured to selectively connect one or more of the multiple serial lines to a convertor module, the convertor module being configured to convert serial communications signals from the one or more connected serial lines to transistor-transistor logic (TTL) level signals;
a communications module; and
a processor configured to: capture data from the TTL level signals received from the convertor module, generate packets containing the captured data, and transmit the packets to a communications network through the communications module.

2. The serial tap device of claim 1 wherein the switch comprises a manually configurable switch.

3. The serial tap device of claim 1 wherein the processor is configured to execute instructions to configure the switch.

4. The serial tap device of claim 3 further comprising a memory having stored thereon one or more files of configuration instructions, and wherein each file, when executed by the processor, causes the processor to configure the serial tap device to capture data from serial communications signals transmitted according to a particular serial communications protocol.

5. The serial tap device of claim 1 wherein the processor is configured to filter data captured from the TTL level signals and generate packets of data according to one or more filter criteria.

6. The serial tap device of claim 5 wherein the filter criteria excludes process control communications.

7. The serial tap device of claim 5 wherein the filter criteria comprises a Universal Product Code (UPC), a portion of a UPC, a product name, or a combination thereof.

8. The serial tap device of claim 4 wherein the serial communications protocol comprises an RS-232, PS/2, RS-422, RS-423, RS-485, SDI-12, SPI, 1-Wire, I2C, Universal Serial Bus (USB), or Musical Instrument Digital Interface (Midi) protocol.

9. The serial tap device of claim 1 further comprising at least one diode between the switch and the convertor module.

10. The serial tap device of claim 1 wherein the communications module is configured to support wired communications, wireless communications, or a combination thereof.

11. The serial tap device of claim 10 wherein the wireless communications are any one of WiFi™, Bluetooth™, Zigbee™, code-division multiple access (CDMA), time-division multiple access (TDMA), Global System for Mobile Communications (GSM™), Universal Mobile Telecommunications System (UMTS), Long-Term Evolution (LTE™), General Packet Radio Service (GPRS), Evolution-Data Optimized (EVDO), Enhanced Data rates for GSM Evolution (EDGE), or Integrated Digital Enhanced Network (iDEN) communications.

12. A serial tap device comprising
a first serial port,
a second serial port directly connected to the first serial port by multiple serial lines;
a convertor module connected to a selected subset of the multiple serial lines, the convertor module being configured to convert serial communications signals captured from the connected serial lines to transistor-transistor logic (TTL) level signals;
a communications module; and
a processor configured to: capture data from the TTL level signals received from the convertor module, generate packets containing the captured data, and transmit the packets to a communications network through the communications module.

13. The serial tap device of claim 12 wherein the processor is further configured filter data captured from the TTL level signals and generate packets of data according to one or more filter criteria.

14. The serial tap device of claim 13 where in the filter criteria excludes process control communications.

15. The serial tap device of claim 13 wherein the filter criteria comprises a Universal Product Code (UPC), a portion of a UPC, a product name, or a combination thereof.

16. The serial tap device of claim 12 further comprising a diode between the at least one connected serial line and the convertor module.

17. The serial tap device of claim 13 wherein the convertor module is connected to the selected subset of multiple serial lines necessary for capturing data from serial communications transmitted according to an RS-232, PS/2, RS-422, RS-423, RS-485, SDI-12, SPI, 1-Wire, I2C, Universal Serial Bus (USB), or Musical Instrument Digital Interface (Midi) protocol.
